(19) United States
(12) Patent Application Publication
(10) Pub. No.: US 2007/0041383 A1
(43) Pub. Date: Feb. 22, 2007

(54) Third party node initiated remote direct memory access

(76) Inventors: Mohmmad Banikazemi, New York, NY (US); Jiuxing Liu, White Plains, NY (US)

Correspondence Address: LAW OFFICE OF IDO TUCHMAN (YOR), 82-70 BEVERLY ROAD, KEW GARDENS, NY, 11415, US

(21) Appl. No.: 11/099,842

(22) Filed: Apr. 5, 2005

(51) Int. Cl. H04L 12/56

(52) U.S. Cl. 370/395.3; 709/217

(57) ABSTRACT

The present invention introduces a third party node initiated remote direct memory access scheme for transferring data from a source node to destination node. The third party node is a different node than the source node and the destination node and the data transfer is configured to occur without involvement of a source node processor and a destination node processor. One embodiment of the invention includes an initiator node and a transfer instruction. The initiator node is configured to initiate a data transfer between the source node and the destination node. The transfer instruction configured to be transmitted to either the source node or the destination node by the initiator node, and to effectuate the data transfer without involvement of a source node processor and a destination node processor.

### FIELD OF THE INVENTION

The present invention relates generally to data transfer operations between nodes in a computer network. More specifically, the invention relates to remote direct memory access operations between source and destination nodes that are initiated by a third party node.

### BACKGROUND

Computers are often conceptualized into three separate units: a processing unit, a memory unit, and an input/output (I/O) unit. The processing unit performs computation and logic operations, the memory unit stores data and program code, and the I/O unit interfaces with external components, such as a video adapter or network interface card.

Early computer designs typically required the processing unit to be involved in every operation between the memory unit and the I/O unit. For example, if network data needed to be stored in the computer's memory, the processing unit would read the data from the I/O unit and then write the data to the memory unit.

One drawback of this approach is that it places a heavy burden on the processing unit when large blocks of data are moved between the I/O and memory units. This burden can significantly slow a computer's performance by requiring program execution to wait until such data transfers are completed before program execution can continue. In response, Direct Memory Access (DMA) was created to help free the processing unit from repetitive data transfer operations between the memory unit and the I/O unit.

The idea behind DMA is that block data transfers between the I/O and memory units are performed independent of the processing unit. The processing unit is only minimally involved in DMA operations by configuring data buffers and ensuring that important data is not inadvertently overwritten. DMA helps free up the processing unit to perform more critical tasks such as program execution rather than spend precious computational power shuttling data back and forth between the I/O and memory units like an underappreciated soccer mom.

DMA has worked well in many computer systems, but with the ever-increasing volume of data being transferred over computer networks, processing units are once again becoming overburdened with data transfer operations in some network configurations. This is because processing units typically must still be involved in each data transfer

To address this issue, Remote Direct Memory Access (RDMA) operations have been introduced.

Modern communication subsystems, such as InfiniBand(IB) Architecture, provide the user with memory semantics in addition to the standard channel semantics. The traditional channel operations (also known as Send/Receive operations) refer to two-sided communication operations where one party initiates the data transfer and another party determines the final destination of the data. With memory semantics, however, the initiating party (local node) specifies a data buffer on the other party (remote node) for reading from or writing to. The remote note does not need to get involved in the data transfer itself. These types of operations are also referred to as Put/Get operations and Remote Direct Memory Access (RDMA) operations.

RDMA operations can be divided into two major categories: RDMA read and RDMA write operations. RDMA read operations are used to transfer data from a remote node to a local node (i.e., the initiating node). RDMA write operations are used for transferring data to a remote node. For RDMA read operations, the address (or a handle which refers to an address) of the remote buffer from which the data is read and a local buffer into which the data from the remote buffer is written to are specified. For RDMA write operations, a local buffer and the address of the remote buffer into which the data from the local buffer is written are specified.

In addition to read and write operations, another operation usually referred to as RDMA atomic operation has been defined in the IB Architecture Specification. This operation is defined as a combined read, modify, and write operation carried out in an atomic fashion. For this operation a remote memory location is required to be specified.

There are three components in an RDMA operation: the initiator, the source buffer, and the destination buffer. In an RDMA write operation, the initiator and the source buffer are at the same node, and the destination buffer is at a remote node. In an RDMA read operation, the initiator and the destination buffer are at the same node, and the source buffer is at a remote node. At a remote node, RDMA read and RDMA write operations are handled completely by the hardware of the network interface card. There is no involvement of the remote node software. Therefore, RDMA operations can reduce host overhead significantly, especially for the remote node.

In some scenarios, data transfers involve more than two nodes. For example, in a cluster-based cooperative caching system, a control node may need to replicate a cached page from one caching node (node that uses its memory as a cache) to another caching node. Another example is a cluster based file system in which a node that serves user file requests may need to initiate data transfer from a disk node to the original node that sent the request. In these cases, the initiator of the data transfer operation is at a different node than either the source node or the destination node. This type of data transfer is referred to herein as “third party transfer.” Generally, current RDMA operations cannot be used directly to accomplish this kind of data transfer.

Third party transfer can be achieved by using current RDMA operations indirectly. There are two ways to do this. The first way is to transfer the data from the source node to the initiator using RDMA read, and then transfer it to the destination node using RDMA write. In this way, neither the source node nor the destination node software is involved in the data transfer. Therefore, the CPU overhead is minimized for these nodes. However, network traffic is increased since the data is transferred twice in the network. The overhead at the initiator node is also increased.

The second way for doing third party transfer using current RDMA operations is to first send an explicit message to an intermediate node that is either the source node or the destination node. The node which receives the message then uses RDMA read or write to complete the data transfer. In this method, data is transferred through the network only once. However, the control message needs to be processed by the software of the intermediate node, requiring the processing unit to get involved. Thus, this second method increases the processing unit overhead of the node. Furthermore, if the message processing at the intermediate node is delayed, the latency of the data transfer will increase.

### SUMMERY OF THE INVENTION

The present invention addresses the above-mentioned limitations of the prior art by introducing a mechanism that decouples the source and destination nodes of a Remote Direct Memory Access (RDMA) operation from the operation's initiating node. In accordance with an embodiment of the present invention, an initiator node can initiate an RDMA operation to transfer a buffer from a source node to a destination node in a single operation. Furthermore, the initiator node can be at a different node from the source and the destination nodes.

Thus, one exemplary aspect of the present invention is a method for transferring data from a source node to a destination node. The method includes issuing an initiate transfer instruction from an initiator node processor to an initiator node network adapter. A receiving operation receives the initiate transfer instruction at the initiator node network adapter. A sending operation sends a transfer instruction from the initiator node's network adapter to a remote node in response to the initiate transfer instruction. The remote node is either the source node or the destination node. The transfer instruction is configured to effectuate the data transfer from the source node to the destination node without involvement of a source node processing unit and a destination node processing unit.

Another exemplary aspect of the present invention is a system for transferring data from a source node to destination node. The system includes an initiator node and a transfer instruction. The initiator node is configured to initiate a data transfer between the source node and the destination node. The transfer instruction is configured to be transmitted to either the source node or the destination node by the initiator node, and to effectuate the data transfer without involvement of a source node processing unit and a destination node processing unit.

Yet a further exemplary aspect of the invention is an initiate data transfer instruction embodied in tangible media for performing data transfer from a source node to a destination node across a computer network. The initiate data transfer instruction includes a source node network address parameter configured to identify a network address of the source node where the data to be transferred resides, a source buffer address parameter configured to identify a memory location of the data at the source node, a destination node network address configured to identify a network address of the destination node where the data is to be transferred to, a destination buffer address parameter configured to identify a memory location at the destination node to receive data, and a data buffer size parameter configured to identify an amount of data to be transferred. The data transfer is configured to occur without involvement of a source node processing unit and a destination node processing unit.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows one configuration of an exemplary environment embodying the present invention.

FIG. 2 shows a second configuration of an exemplary environment embodying the present invention.

FIG. 3 shows the exemplary environment in more detail.

FIG. 4 shows a flowchart of system operations performed by one embodiment of the present invention.

FIG. 5 shows parameters for an initiate transfer directive, as contemplated by one embodiment of the present invention.

### DETAILED DESCRIPTION OF THE INVENTION

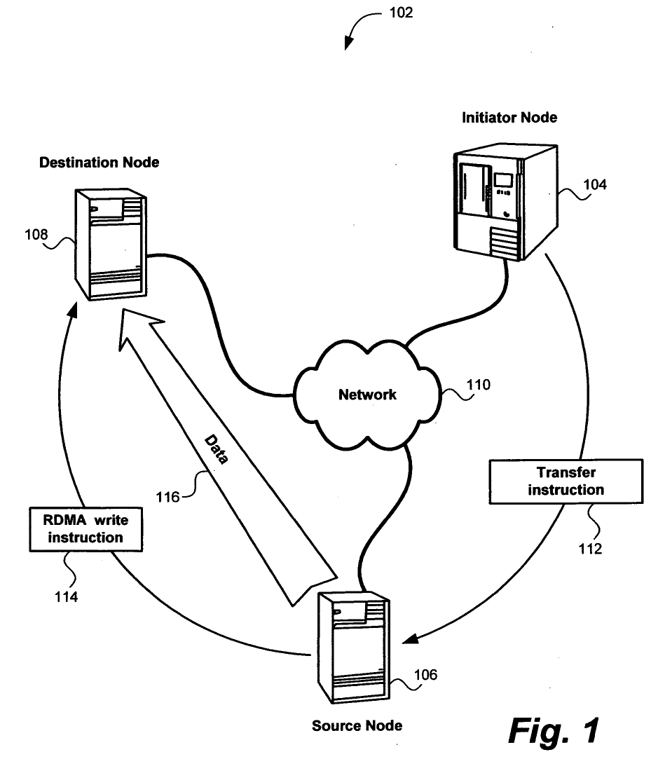

The following description details how the present invention is employed to enhance Remote Direct Memory Access (RDMA) operations between source and destination nodes. Throughout the description of the invention reference is made to FIGS. 1-5. When referring to the figures, like structures and elements shown throughout are indicated with like reference numerals.

FIG. 1 shows an exemplary environment 102 embodying the present invention. It is initially noted that the environment 102 is presented for illustration purposes only, and is representative of countless configurations in which the invention may be implemented. Thus, the present invention should not be construed as limited to the environment configurations shown and discussed herein.

The environment 102 includes an initiator node 104, a source node 106, and a destination node 108 coupled to a network 110. It is contemplated that the initiator, source and destination nodes may be independent of each other or may be organized in a cluster, such as a server farm. For example, the nodes may belong to a load balance group, with the initiator node 104 acting as the master or primary node. Furthermore, although the nodes are shown physically dispersed from each other, it is contemplated that the nodes may exist in a common enclosure, such as a server rack.

The computer network 110 may be a Local Area Network (LAN), a Wide Area Network (WAN), a Storage Area Network (SAN), or a combination thereof. It is contemplated that the computer network 110 may be configured as a public network, such as the Internet, and/or a private network, such as an Intranet, and may include various topologies and protocols known to those skilled in the art, such TCP/IP and UDP. Furthermore, the computer network 110 may include various networking devices known to those skilled in the art, such as routers, switches, bridges, repeaters, etc.

The environment 102 supports Third Party Initiated Remote Direct Memory Access (TPI RDMA) commands in accordance with one embodiment of the present invention. For this to occur, the initiator node 104 is configured to coordinate a data transfer between the source node 106 and the destination node 108 with minimal involvement of the initiator, source and destination nodes' processing units.

Specifically, a transfer instruction 112 is issued by the initiator node 104 to a network card of either the source node 106 or destination node 108. The transfer instruction 112 is embodied in tangible media, such as a magnetic disk, an optical disk, a propagating signal, or a random access memory device. In one embodiment of the invention, the transfer instruction 112 is a TPI RDMA command fully executable by a network interface card (NIC) receiving the command without burdening the host processor where the NIC resides.

The choice of which remote node the initiator node 108 contacts may be arbitrary or may based on administrative criteria, such as network congestion. In FIG. 1, the initiator node 104 is shown issuing the transfer instruction 112 to the source node 106. As discussed below, the transfer instruction 112 includes the source node's network location, the destination node's network location, the data location, and a buffer size.

Once the source node 106 receives the transfer instruction 112, it is recognized and acted upon by the source node's network card without involvement of the source node's processing unit. Next, the source node's network card issues an RDMA write instruction 114 to the destination node's network card, which results in data transfer from the source node 106 to the destination node 108. In a particular embodiment of the invention, data 116 is sent from the source node 106 to the destination node 108 in one step such that the RDMA write instruction 114 and the data 116 are combined in a single packet. For example, data 116 may be marked with special information informing the destination node 108 that it is for an RDMA write operation.

As discussed in more detail below, the present invention beneficially performs data transfers from a buffer in one remote node to a buffer in another remote node. Such data transfers can occur in a single operation and without requiring the transfer of data to an intermediate node. In TPI RDMA operations, software is not involved in the data transfer (if the initiator is different from the source and the destination) at either the source node 106 or the destination node 108. Furthermore, the data is only transferred once in the network, which results in minimum network traffic.

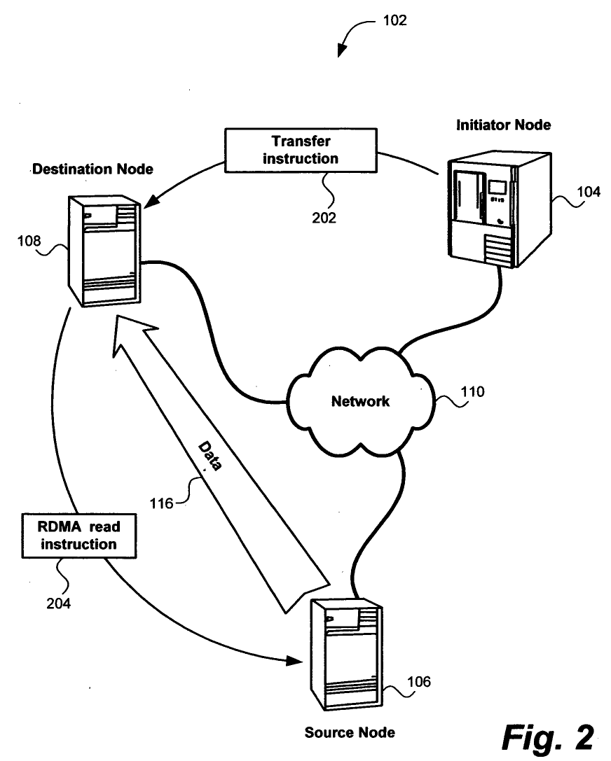

Referring to FIG. 2, the environment 102 is shown with the destination node 108 as the recipient of the transfer instruction 202 from the initiator node 104 rather than the source node 106. In this scenario, the network card of the destination node 108 processes the transfer instruction 202 without involvement of the destination node's processing unit. The destination node 108 then issues an RDMA read instruction 204 to the source node 106. After the RDMA read instruction 204 is sent to the source node 106, the specified data 116 is transferred from the source node 106 to the destination node 108. Again, in this configuration, there is minimal involvement of the initiator, source and destination nodes' processing units along with minimal network traffic.

As mentioned above, the transfer instruction may be a TPI RDMA operation. Generally, there are three components in an RDMA operation: the initiator, the source buffer, and the destination buffer. In an RDMA write operation, the initiator and the source buffer are at the same node, and the destination buffer is at a remote node. In an RDMA read operation, the initiator and the destination buffer are at the same node. As disclosed in detail below, embodiments of the present invention are directed toward a new and more flexible RDMA operation in which both source and destination can be remote nodes. In such schemes, an RDMA operation (data transfer) can be performed in a single operation and without involving the processing unit of an intermediate node. Furthermore, the data is only transferred once in the network, which results in minimum network traffic. The present invention can be used in a large number of systems such as distributed caching systems, distributed file servers, storage area networks, high performance computing, and the like.

In a TPI RDMA operation, the initiator node 104 specifies both the source buffer and the destination buffer of the data transfer, as well as the buffer size. Both buffers can be at different nodes than the initiator node 104. After the successful completion of the operation, the destination buffer will have the same content as the source buffer. If the operation cannot be finished, error information is returned to the initiator node 104.

To specify a buffer in a TPI RDMA operation, information is provided to identify both the buffer address and the node at which the buffer is located. In some cases, a node can have multiple network interface cards. Therefore, it may be necessary to specify not only the node, but also the network interface card the access uses.

Some RDMA mechanisms also include certain kinds of protection mechanism to prevent one node from writing arbitrarily to others' memory. It is contemplated that in one embodiment of the invention, TPI RDMA operations are compliant with at least one such protection mechanism. For instance, the TPI RDMA access can be authorized under the protection mechanism by providing proper authorization information such as keys or capabilities.

In accordance with one embodiment of the present invention, once initiated, a TPI RDMA operation is handled completely in hardware with the help of network interface cards. First, a control packet that contains proper buffer and authorization information is sent to an intermediate node that is either the source or destination node. The network interface of the intermediate node then processes the control packet and converts it to an operation that is similar to a traditional RDMA operation. After this operation is completed, an acknowledgement packet may be sent back to the initiator.

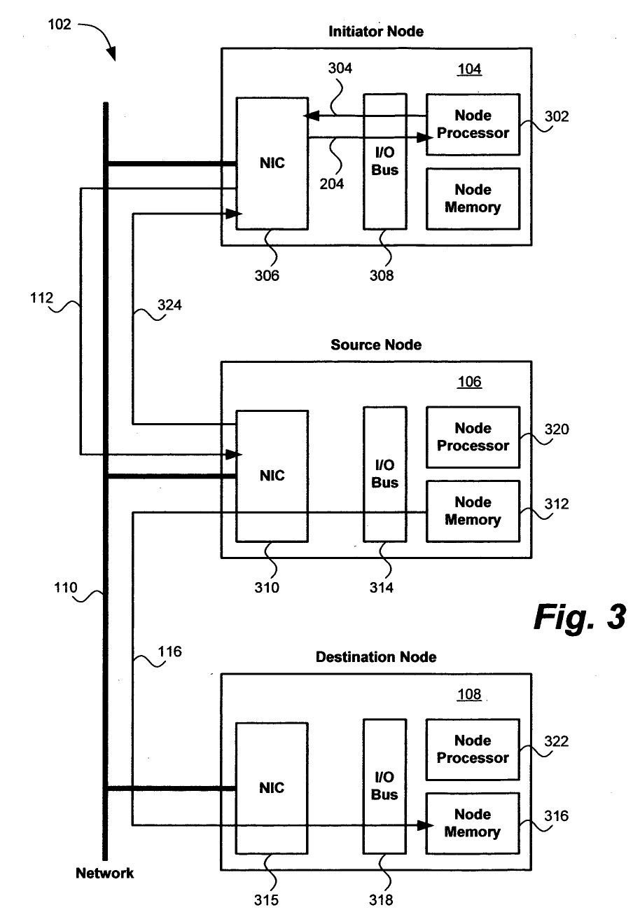

FIG. 3 shows the exemplary environment 102 in more detail. In accordance with an embodiment of the present invention, the initiator node 104 commences a TPI RDMA operation at its processor unit 302 by issuing an initiate transfer instruction 304 to its NIC 306 via the initiator node's I/O bus 308. The initiate transfer instruction 304 may include the network address of the source node 106, the network address of the destination node 108, identification of specific NICs at each node, the data location at the source node, a buffer size to be transferred, and any necessary authorization codes.

Upon receiving the initiate transfer instruction 304, the initiator node's NIC 306 issues a transfer instruction 112 to either the source or destination node specified in the initiate transfer instruction 304. Preferably, the transfer instruction 112 is a TPI RDMA operation. It should be noted that TPI RDMA operations may need proper initialization before they can be used. For example, some RDMA operations use reliable connection service. In these cases, it may be necessary to first set up proper connections between the initiator, the source node, and the destination node.

Upon receiving the transfer instruction 112 from the initiator node 104, the source node's NIC 310 executes an RDMA write operation 116. This involves accessing the data in the source node's memory 312 through the source node's I/O bus 314 and transferring the data to the destination node 108. At the destination node 108, the data passes through the destination node's NIC 315 to the destination node's memory 316 via the destination node's I/O bus 318. Note that the TPI RDMA operation does not require the source node processor 320 or the destination node processor 322 to be involved.

It is contemplated that upon successful completion of the TPI RDMA operation, the node originally contacted by the initiator node 104 (in the case of FIG. 3, it is the source node 106) sends an Acknowledgement message 324 back to the initiator node 104. In addition, the Acknowledgement message 324 may also inform the initiator node 104 if any errors or problems occurred during the TPI RDMA operation.

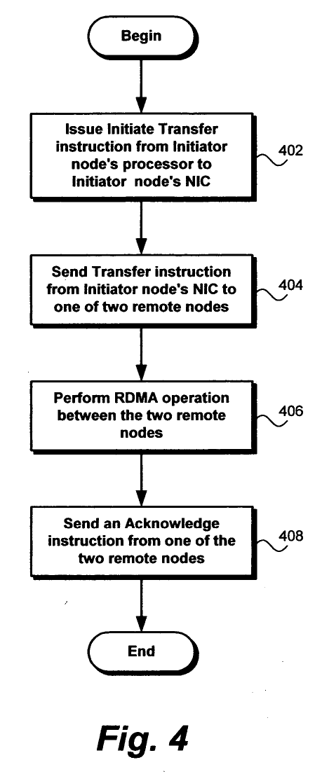

In FIG. 4, a flowchart of system operations performed by one embodiment of the present invention is shown. It should be remarked that the logical operations shown may be implemented in hardware or software, or a combination of both. The implementation is a matter of choice dependent on the performance requirements of the system implementing the invention. Accordingly, the logical operations making up the embodiments of the present invention described herein are referred to alternatively as operations, steps, or modules.

Operational flow begins with issuing operation 402. During this operation, the initiator node sends an initiate transfer directive from its processor to its NIC. As used herein, a “node processor” or “node processing unit” is defined as a processing unit configured to control the computer's overall activities and is located outside the memory unit and I/O devices.

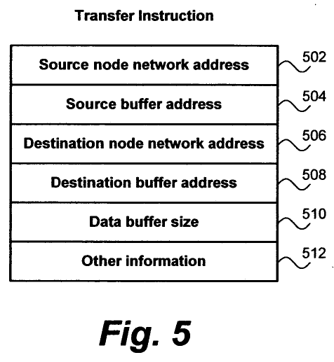

Referring to FIG. 5, the initiate transfer directive typically includes the following parameters:

Source node network address 502—network address of the node where the data to be transferred resides.

Source buffer address 504—memory location of the data at the source node.

Destination node network address 506—network address of the node where the data is to be transferred to.

Destination buffer address 508—memory location at the destination node to receive data.

Data buffer size 510—amount of data to be transferred.

Other information 512—includes control flags, security authorization, etc.

It is contemplated that the source and destination network addresses may identify specific NICs at the source and destination nodes if these nodes contain more than one NIC. Returning to FIG. 4, after the issuing operation 402 is completed, control passes to sending operation 404.

At sending operation 404, the initiator node's NIC issues a transfer directive to either the source node or the destination node. The transfer directive instructs the receiving node to perform an RDMA operation as specified in the initiate transfer directive described above. Thus, the transfer directive also includes parameters such as the source node network address, the source buffer address, the destination node network address, the destination buffer address, the data buffer size, and other information. After sending operation 404 has completed, control passes to performing operation 406.

At performing operation 406, the NIC receiving the transfer directive from the initiating node performs an RDMA operation on the data specified in the transfer directive. For example, if the transfer directive is issued to the source node, then the RDMA instruction is a RDMA write instruction. Conversely, if the transfer directive is issued to the destination node, then the RDMA instruction is a RDMA read instruction.

As discussed above, the performing operation 406 is administered by source and destination NICs without the processors of either the source, destination or initiator nodes being involved. This minimizes the burdens that the source, destination and initiator processing units so that computation power can be devoted to other tasks. As a result, system performance is improved at all three nodes.

After performing operation 406 is completed, control passes to sending operation 408. During this operation, the source node and/or the destination node notify the initiator node that the RDMA operation was successfully completed or if any problems occurred during the data transfer. In other words, TPI RDMA operations can generate a completion notification when the acknowledgement is received. The notification can optionally trigger an event handling mechanism at the initiator node. TPI RDMA operations can optionally generate completion notifications at the source node and the destination node. If sending operation 408 reports a problem to the initiator node, the initiator node can then attempt corrective actions. If sending operation 408 reports that the RDMA operation was successful, the process is ended.

The foregoing description of the invention has been presented for purposes of illustration and description. It is not intended to be exhaustive or to limit the invention to the precise form disclosed, and other modifications and variations may be possible in light of the above teachings. For example, TPI RDMA operations may be guaranteed to complete in order only when they have the same source and destination nodes (and the access passes through the same NIC at each node) for the same initiator node. Otherwise, ordering is not guaranteed unless explicit synchronization instruction is given.

The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. An initiate data transfer instruction embodied in tangible media for performing data transfer from a source node to a destination node across a computer network, the initiate data transfer instruction comprising:
a source node network address parameter configured to identify a network address of the source node where the data to be transferred resides;
a source buffer address parameter configured to identify a memory location of the data at the source node;
a destination node network address configured to identify a network address of the destination node where the data is to be transferred to;
a destination buffer address parameter configured to identify a memory location at the destination node to receive data; and
a data buffer size parameter configured to identify an amount of data to be transferred; and
wherein the data transfer is configured to occur without involvement of a source node processing unit and a destination node processing unit.

2. The initiate data transfer instruction of claim 1, wherein the initiate transfer instruction is configured to be issued by an initiator node, the initiator node being a different node than the source node and the destination node.

3. The initiate data transfer instruction of claim 1, wherein the initiate transfer instruction is configured to initiate a Remote Direct Memory Access operation between the source node and the destination node.

4. The initiate data transfer instruction of claim 1, further comprising a security authorization parameter configured to allow access to the data.

5. A system for transferring data from a source node to destination node, the system comprising:
an initiator node configured to initiate a data transfer between the source node and the destination node; and
a transfer instruction configured to be transmitted to either the source node or the destination node by the initiator node, the transfer instruction further configured to effectuate the data transfer without involvement of a source node processing unit and a destination node processing unit.

6. The system of claim 5, further comprising a Remote Direct Memory Access (RDMA) operation configured to transfer the data from the source node to the destination node.

7. The system of claim 5, wherein the transfer instruction includes:
a source buffer address parameter configured to identify a memory location of the data at the source node;
a destination buffer address parameter configured to identify a memory location at the destination node to receive data; and
a data buffer size parameter configured to identify an amount of data to be transferred.

8. The system of claim 7, wherein the transfer instruction includes a security authorization parameter configured to allow access to the data.

9. The system of claim 5, wherein the initiator node is a different node than the source node and the destination node.

10. The system of claim 5, further comprising a RDMA read operation issued from the destination node to the source node.

11. The system of claim 5, further comprising a RDMA write operation issued from the source node to the destination node.

12. A method for transferring data from a source node to a destination node, the method comprising:
issuing an initiate transfer instruction from an initiator node processor to an initiator node network adapter;
receiving the initiate transfer instruction at the initiator node network adapter;
sending a transfer instruction from the initiator node network adapter to a remote node in response to the initiate transfer instruction, the remote node being one of the source node and the destination node, the transfer instruction configured to effectuate the data transfer from the source node to the destination node without involvement of a source node processing unit and a destination node processing unit.

13. The method of claim 12, wherein the initiator node is a different node than the source node and the destination node.

14. The method of claim 12, wherein the initiate transfer instruction includes:
a source node network address parameter configured to identify a network address of the source node where the data to be transferred resides;
a source buffer address parameter configured to identify a memory location of the data at the source node;
a destination node network address configured to identify a network address of the destination node where the data is to be transferred to;
a destination buffer address parameter configured to identify a memory location at the destination node to receive data; and
a data buffer size parameter configured to identify an amount of data to be transferred.

15. The method of claim 12, wherein the initiate transfer instruction is configured to initiate a Remote Direct Memory Access operation between the source node and the destination node.

16. The method of claim 12, wherein the initiate transfer instruction includes a security authorization parameter configured to allow access to the data.

17. The method of claim 12, wherein the transfer instruction includes:
a source buffer address parameter configured to identify a memory location of the data at the source node;
a destination buffer address parameter configured to identify a memory location at the destination node to receive data; and
a data buffer size parameter configured to identify an amount of data to be transferred.

18. The method of claim 12, wherein the transfer instruction includes a security authorization parameter configured to allow access to the data.

19. The method of claim 12, further comprising sending a RDMA read operation from the destination node to the source node.

20. The method of claim 12, further comprising sending a RDMA write operation from the source node to the destination node.
